(19) United States
(12) Patent Application Publication
(10) Pub. No.: US 2026/0061499 A1
(43) Pub. Date: Mar. 5, 2026

(54) CUTTING UNIT, CUTTING TOOL, CUTTING TOOL REST, AND METHOD FOR MANUFACTURING CUT ARTICLE

(71) Applicant: KYOCERA CORPORATION, Kyoto (JP)

(72) Inventors: Youji KOBAYASHI, Kyoto (JP); Naoki YUKIMOTO, Kyoto (JP)

(21) Appl. No.: 19/105,339

(22) PCT Filed: Aug. 14, 2023
(86) PCT No.: PCT/JP2023/029397

§ 371 Date: Feb. 21, 2025

(30) Foreign Application Priority Data
Aug. 29, 2022 (JP) 2022-136079

(51) Int. Cl. B23B 31/107; B23B 29/26

(52) U.S. Cl. CPC B23B 31/1078; B23B 29/26; B23B 2231/026

(57) ABSTRACT

To stably hold a holder by a holding block while improving the workability of an operation of attaching the holder to the holding block. A clamp member includes a pressing portion that, in a state of being interposed between one inner side surface of a groove of a holding block and an upper surface of a holder, presses the holder toward the other inner side surface of the groove. The pressing portion includes a first protrusion that comes into contact with a first inclined surface of a first cutout of the holder, and a second protrusion that is separated from the first protrusion and comes into contact with a second inclined surface of a second cutout of the holder.

### DESCRIPTION

### Technical Field

The present disclosure relates to a cutting tool, a cutting tool, and a cutting tool rest, which are used for cutting a workpiece, and a method for manufacturing a cut article.

### Background of Invention

A cutting unit attachable to a machine tool is used if cutting a workpiece made of metal or the like. A cutting unit described in Patent Document 1 includes a holder (a portion obtained by removing a tip from a cutting tool in Patent Document 1), and a cutting edge located at the front end of the holder and on a side of a first side surface. The cutting unit described in Patent Document 1 includes a holding block (referred to as a cutting tool holder in Patent Document 1) including a groove (referred to as a recessed groove in Patent Document 1) that holds the holder, and a clamp member that fixes the holder to the holding block.

The clamp member includes two tightening bolts screwed into the holding block, and pressing pieces coupled to front end portions of the two tightening bolts, respectively. In a state of being interposed between one inner side surface of the groove of the holding block and the upper surface of the holder, the two pressing pieces press the holder toward the other inner side surface of the groove of the holding block. A first pressing piece of the two pressing pieces comes into contact with an inclined surface of a first cutout among two cutouts (referred to as a cutout in Patent Document 1) of the holder. A second pressing piece of the two pressing pieces comes into contact with an inclined surface of a second cutout among the two cutouts of the holder.

### CITATION LIST

### Patent Literature

Patent Document 1: JP 02-048164 UM-B

### SUMMARY

A cutting unit according to the present disclosure includes a holder, a cutting edge, a holding block, and a clamp member. A holder has a quadrangular prism shape extending from a front end toward a rear end, and includes a front end surface located on a side of the front end, an upper surface extending from the front end surface toward the rear end, a lower surface located on a side opposite to the upper surface, a first side surface located between the upper surface and the lower surface and extending from the front end surface toward the rear end, and a second side surface located on a side opposite to the first side surface. A cutting edge is located at the front end and on a side of the first side surface. A holding block includes a groove configured to hold the holder. A clamp member is located at the holding block. The clamp member includes a pressing portion and is configured to fix the holder to the holding block. The pressing portion is configured to, in a state of being interposed between one inner side surface of the groove and a body portion, press the holder toward a side of another inner side surface of the groove. The upper surface includes a first cutout including a first inclined surface that becomes increasingly separated from the lower surface with increasing proximity to a side of the rear end, and a second cutout located closer to the rear end than the first cutout, and including a second inclined surface that becomes increasingly separated from the lower surface with increasing proximity to the side of the rear end. The pressing portion includes a first protrusion configured to come into contact with the first inclined surface, and a second protrusion separated from the first protrusion and configured to come into contact with the second inclined surface.

A cutting tool according to the present disclosure includes a holder and a cutting edge. A holder has a quadrangular prism shape extending from a front end toward a rear end, and includes a front end surface located on a side of the front end, an upper surface extending from the front end surface toward the rear end, a lower surface located on a side opposite to the upper surface, a first side surface located between the upper surface and the lower surface and extending from the front end surface toward the rear end, and a second side surface located on a side opposite to the first side surface. A cutting edge is located at the front end and on a side of the first side surface. The upper surface includes a first cutout and a second cutout located closer to the rear end than the first cutout. The first cutout includes a first inclined surface that becomes increasingly separated from the lower surface with increasing proximity to a side of the rear end, and is open at the first side surface and the second side surface. The second cutout includes a second inclined surface that becomes increasingly separated from the lower surface with increasing proximity to the side of the rear end, and is open at the first side surface and the second side surface.

A cutting tool rest according to the present disclosure, to which a cutting tool according to the present disclosure is attachable, includes a holding block and a clamp member. A holding block includes a groove configured to hold the holder. The clamp member is located at the holding block. The clamp member includes a pressing portion and is configured to fix the holder to the holding block. The pressing portion is configured to, in a state of being interposed between one inner side surface of the groove and the upper surface, press the holder toward a side of another inner side surface of the groove. The pressing portion includes a first protrusion configured to come into contact with the first inclined surface, and a second protrusion separated from the first protrusion and configured to come into contact with the second inclined surface.

### BRIEF DESCRIPTION OF THE DRAWINGS

FIG. 1 is a schematic perspective view of a cutting unit according to an embodiment of the present disclosure.

FIG. 2 is a schematic enlarged side view of the cutting unit illustrated in FIG. 1.

FIG. 3 is a schematic top view of the cutting unit illustrated in FIG. 1.

FIG. 4 is a schematic perspective view of a cutting tool according to the embodiment of the present disclosure.

FIG. 5 is a schematic top view of a part of the cutting tool illustrated in FIG. 4.

FIG. 6 is a schematic side view of the cutting tool illustrated in FIG. 4.

FIG. 7 is a schematic bottom view of the cutting tool illustrated in FIG. 4.

FIG. 8 is a schematic enlarged view of the cutting tool illustrated in FIG. 4, as viewed from the front end of the cutting tool.

FIG. 9 is a schematic enlarged cross-sectional view taken along a line IX-IX in FIG. 2.

FIG. 10 is a schematic enlarged view taken along a line X-X in FIG. 6.

FIG. 11 is a schematic enlarged view taken along a line XI-XI in FIG. 6.

FIG. 12 is a schematic perspective view illustrating a clamp member and a plurality of fixing bolts.

FIG. 13 is a schematic perspective view illustrating the clamp member and the plurality of fixing bolts.

FIG. 14 is a schematic cross-sectional view taken along the longitudinal direction of the clamp member.

FIG. 15 is a schematic cross-sectional view taken along a line XV-XV in FIG. 3.

FIG. 16 is a schematic view describing a method for manufacturing a cut article according to the embodiment of the present disclosure.

FIG. 17 is a schematic view illustrating the method for manufacturing the cut article according to the embodiment of the present disclosure.

FIG. 18 is a schematic view illustrating the method for manufacturing the cut article according to the embodiment of the present disclosure.

### DESCRIPTION OF EMBODIMENTS

The two pressing pieces in the cutting unit described in Patent Document 1 are provided independently, and the pressing force of the first pressing piece with respect to the first cutout of the holder and the pressing force of the second pressing piece with respect to the second cutout of the holder are adjusted individually. Therefore, a difference between the pressing force of the first pressing piece and the pressing force of the second pressing piece may become large. Then, a load is concentrated on one of the pressing pieces and one of the tightening bolts, and there is a risk that the durability of the cutting unit deteriorates. There is a risk that one of the pressing pieces serves as a fulcrum and causes a positional shift of the holder. In order to solve these concerns, it is necessary to adjust the tightening forces of the two tightening bolts with high accuracy to reduce the difference between the pressing force of the first pressing piece and the pressing force of the second pressing piece. As a result, in the cutting unit described in Patent Document 1, an operation of attaching the holder to the holding block tends to become complicated.

Therefore, there has been a demand for development of a cutting unit capable of stably holding a holder by a holding block while improving the workability of an operation of attaching the holder to the holding block.

According to one aspect of the present disclosure, a holder can be stably held by a holding block while improving the workability of an operation of attaching the holder to the holding block.

A cutting tool and a method for manufacturing a cut article according to an embodiment of the present disclosure will be described below in detail with reference to the drawings. However, for convenience of description, each of the drawings, which will be referenced below, is a simplified representation of only components necessary for description of the embodiment. Therefore, a cutting unit according to the embodiment of the present disclosure may include an optional component that is not illustrated in each of the drawings to be referenced. The dimensions of the components in each of the drawings do not faithfully represent the actual dimensions of the components, the dimension ratios of each of the members, or the like.

In the present disclosure, a description will be given based on an orthogonal coordinate system XYZ defined by three directions orthogonal to each other. An X direction is a front-rear direction, one side in the X direction is a front side or a front direction, and the other side in the X direction is a rear side or a rear direction. A Y direction is a left-right direction, one side in the Y direction is a left side or a left direction, and the other side in the Y direction is a right side or a right direction. A Z direction is a vertical direction, one side in the Z direction is an upper side or an upward direction, and the other side in the Z direction is a lower side or a downward direction. In the present disclosure, “orthogonal” is not limited to being strictly orthogonal but means that an error of about ±5 degrees is allowed. “Parallel” is not limited to being strictly parallel but means that an error of about ±5 degrees is allowed.

In the drawings, “FF” indicates the front direction, “FR” indicates the rear direction, “L” indicates the left direction, “R” indicates the right direction, “U” indicates the upward direction, and “D” indicates the downward direction.

### Cutting Unit 10

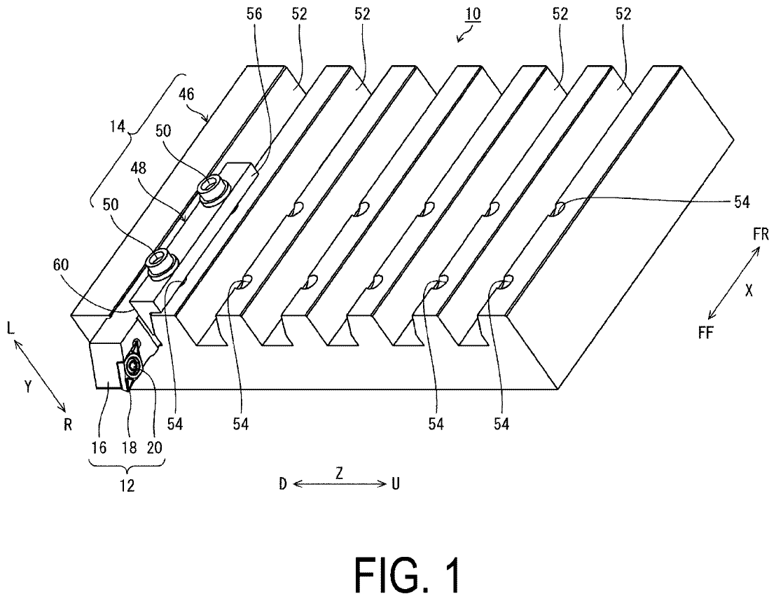

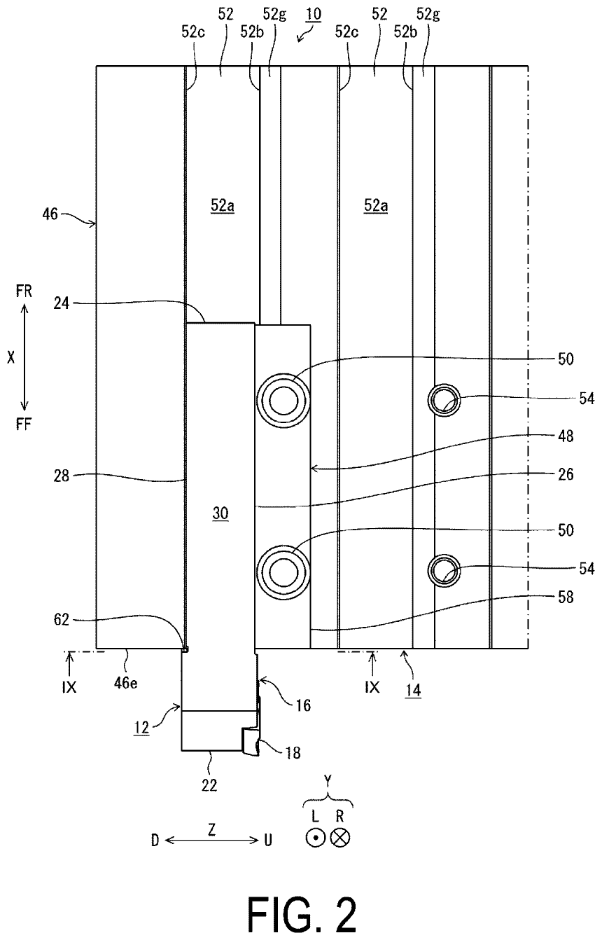

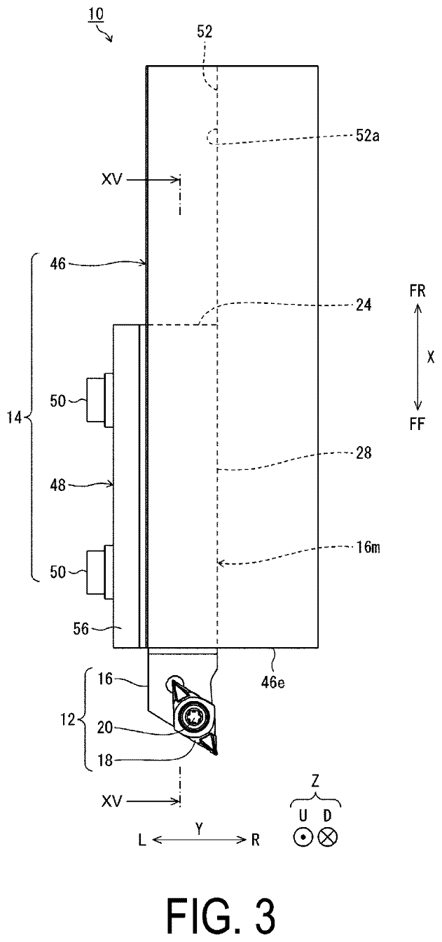

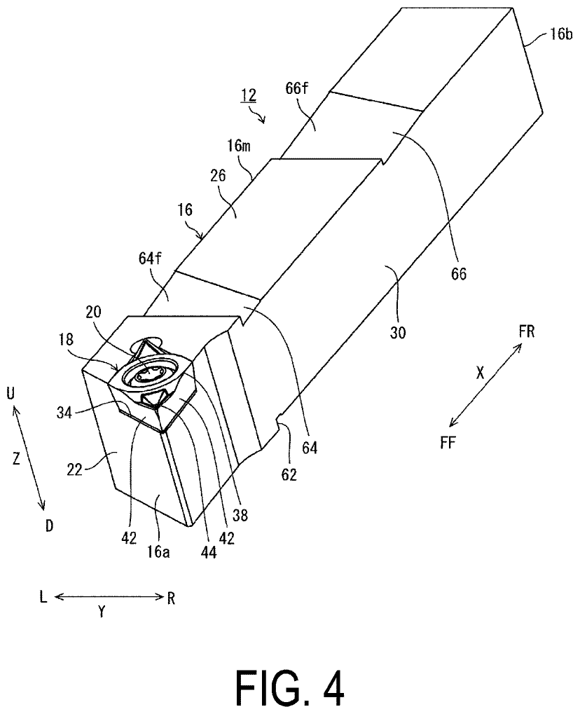

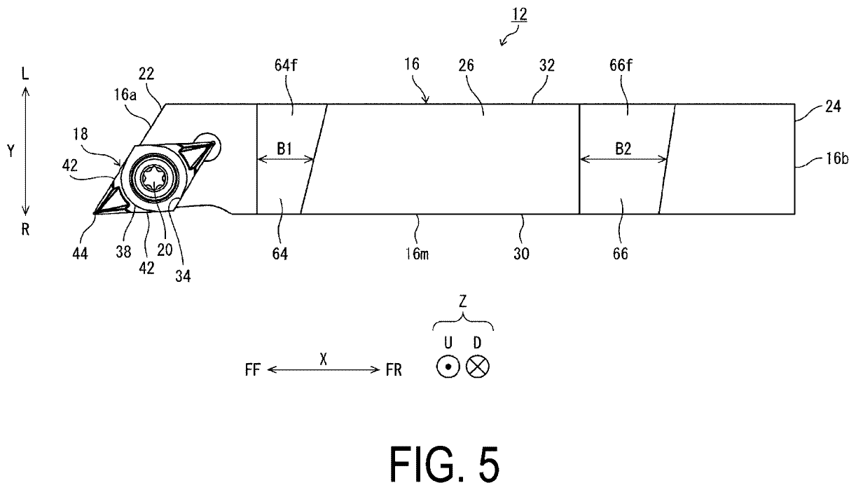

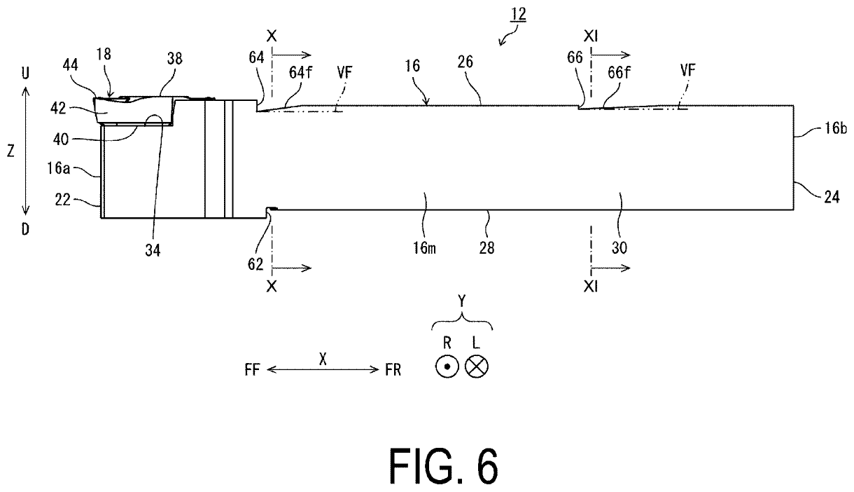

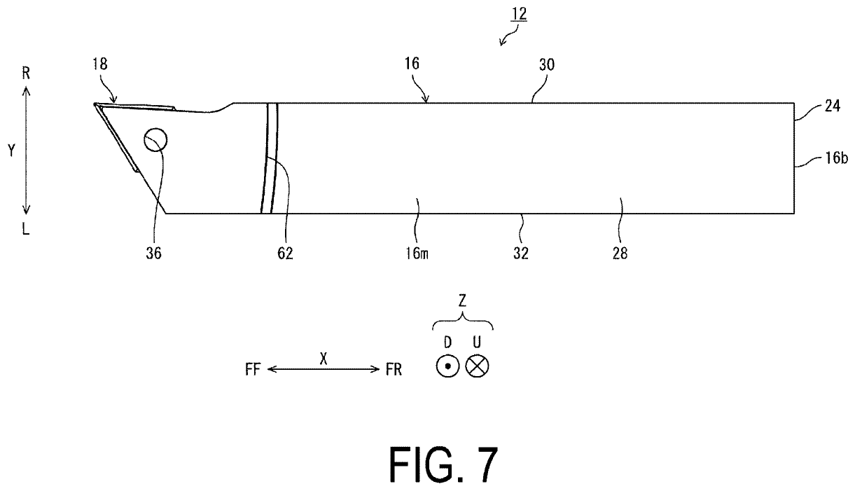

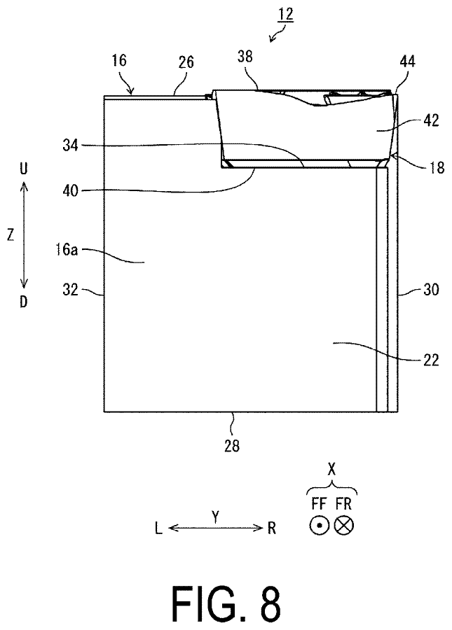

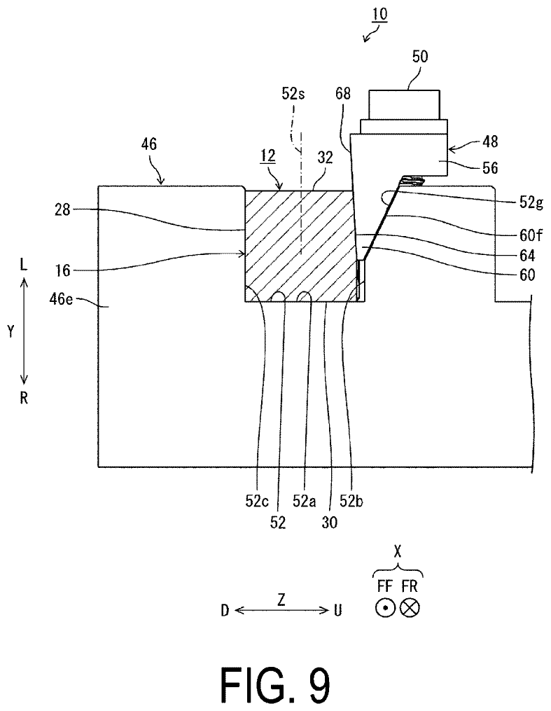

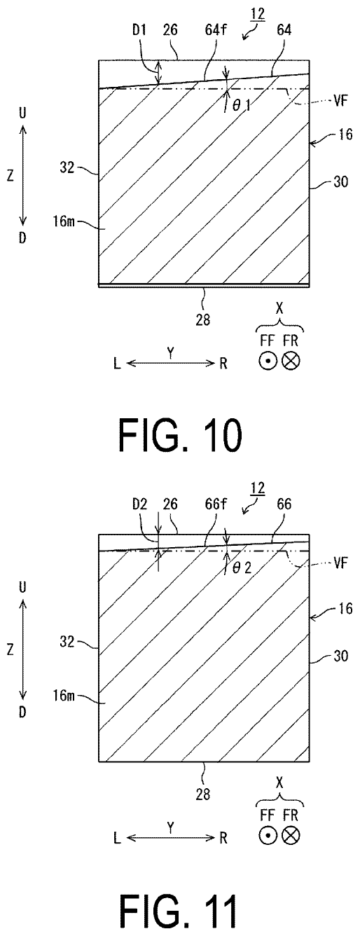

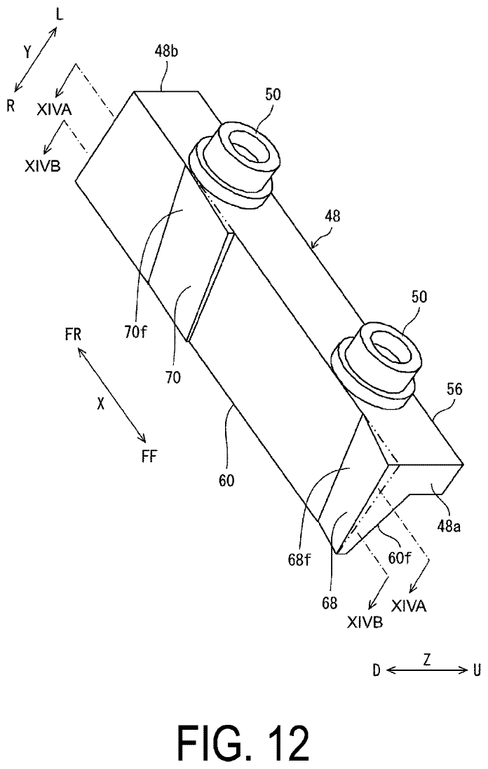

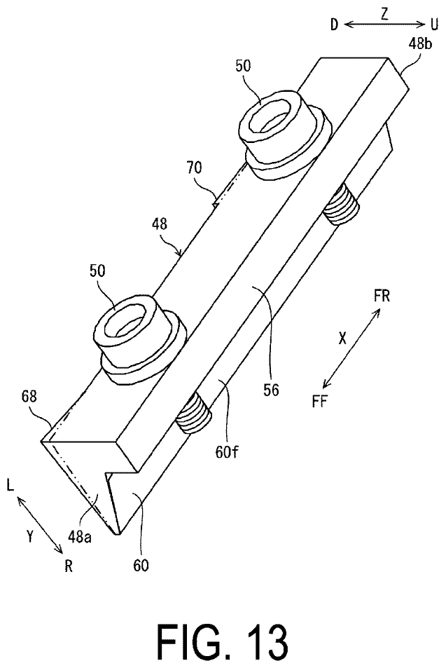

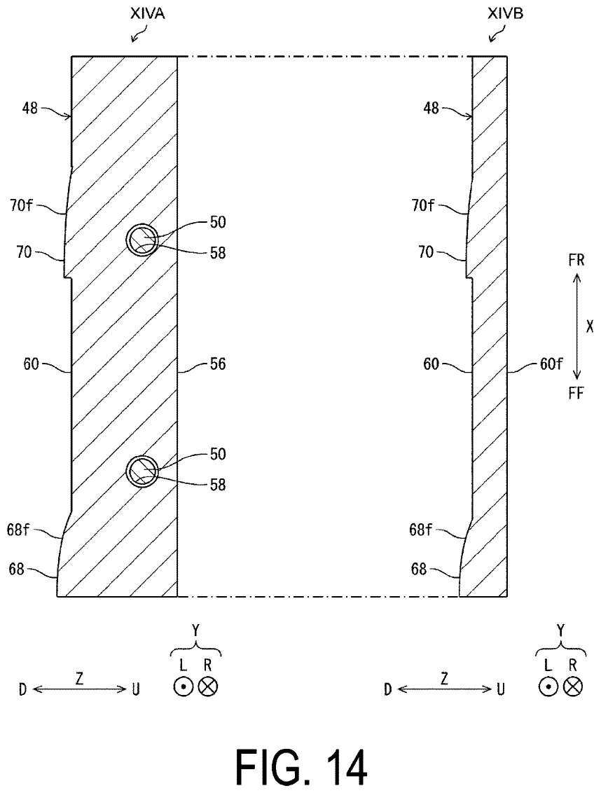

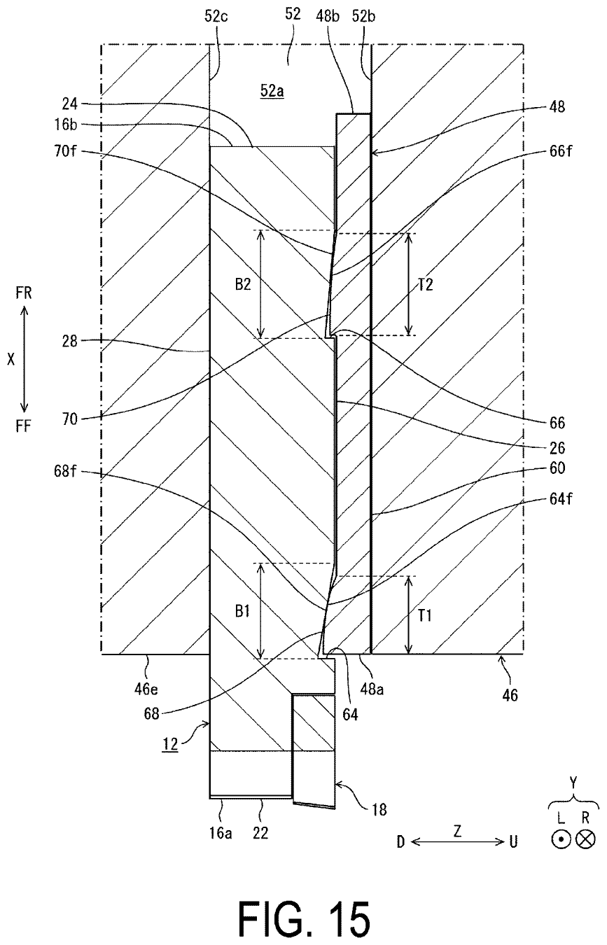

A cutting unit 10 according to the embodiment of the present disclosure will be described with reference to FIGS. 1 to 14. FIG. 1 is a schematic perspective view of the cutting unit 10 according to the embodiment of the present disclosure. FIG. 2 is a schematic enlarged side view of the cutting unit 10 illustrated in FIG. 1. FIG. 3 is a schematic top view of the cutting unit 10 illustrated in FIG. 1. FIG. 4 is a schematic perspective view of a cutting tool 12 according to the embodiment of the present disclosure. FIG. 5 is a schematic top view of the cutting tool 12 illustrated in FIG. 4. FIG. 6 is a schematic side view of the cutting tool 12 illustrated in FIG. 4. FIG. 7 is a schematic bottom view of the cutting tool 12 illustrated in FIG. 4. FIG. 8 is a schematic enlarged view of the cutting tool 12 illustrated in FIG. 4, as viewed from the front end of the cutting tool 12. FIG. 9 is a schematic enlarged cross-sectional view taken along a line IX-IX in FIG. 2. FIG. 10 is a schematic enlarged view taken along a line X-X in FIG. 6. FIG. 11 is a schematic enlarged view taken along a line XI-XI in FIG. 6. FIGS. 12 and 13 are schematic perspective views illustrating a clamp member 48 and a plurality of fixing bolts 50, as viewed from different directions from each other. XIVA of FIG. 14 is a schematic cross-sectional view taken along a line XIVA-XIVA in FIG. 12. XIVB of FIG. 14 is a schematic cross-sectional view taken along a line XIVB-XIVB in FIG. 12. FIG. 15 is a schematic cross-sectional view taken along a line XV-XV in FIG. 3.

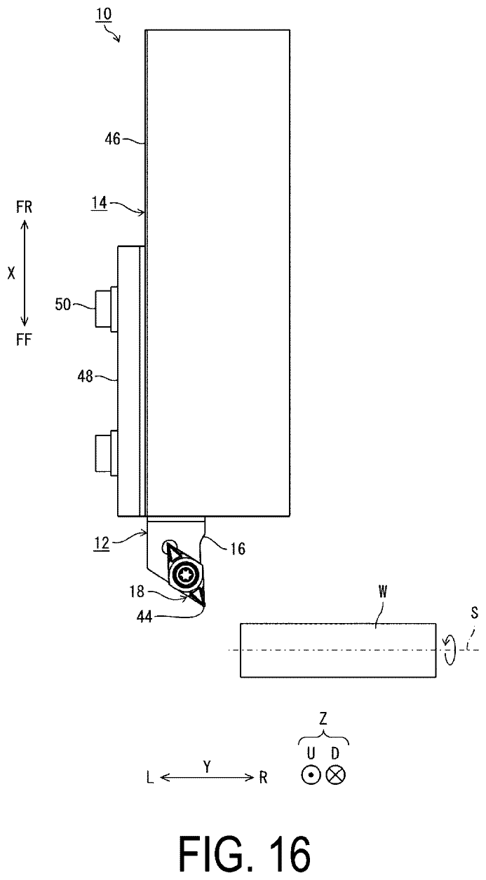

As in the example illustrated in FIGS. 1 to 3, the cutting unit 10 according to the embodiment of the present disclosure is a unit used for cutting a workpiece W (see FIG. 16). The cutting of the workpiece W includes external turning, groove-forming, cutting-off, and the like. The cutting unit 10 may include the cutting tool 12 for cutting the workpiece W, and a cutting tool rest 14 to which the cutting tool 12 is attachable.

As in the example illustrated in FIGS. 4 to 7, the cutting tool 12 may include a holder 16 mounted on the cutting tool rest 14, a cutting insert 18 held by the holder 16, and a clamp screw 20 that fixes the cutting insert 18 to the holder 16. The holder 16 may have a quadrangular prism shape extending along the X direction from a front end 16a toward a rear end 16b. The longitudinal direction of the holder 16 may be the X direction.

In the present disclosure, “the holder 16 having the quadrangular prism shape” means not only that the holder 16 has a strictly quadrangular prism shape but also means that the holder 16 includes a quadrangular prism-shaped body portion 16m so that the holder 16 can be visually recognized as having a substantially quadrangular prism shape on the whole. One end of the body portion 16m of the holder 16 may be located closer to the rear end 16a than the front end 16b of the holder 16. The other end of the body portion 16m of the holder 16 may coincide with the rear end 16b of the holder 16. The body portion 16m held by the cutting tool rest is also referred to as a shank.

As in the example illustrated in FIGS. 4 to 8, the holder 16 includes a front end surface 22 located on a side of the front end 16a, and a rear end surface 24 located on a side opposite to the front end surface 22. The front end surface 22 of the holder 16 is not limited to one flat surface, and may include a plurality of flat surfaces and/or curved surfaces. The holder 16 may include an upper surface 26 extending in the X direction from the front end surface 22 toward the rear end 16b to the rear end surface 24. The holder 16 may include a lower surface 28 located on a side opposite to the upper surface 26, and the lower surface 28 may extend in the X direction from the front end surface 22, toward the rear end 16b, to the rear end surface 24.

As illustrated in FIGS. 4 to 6 and FIG. 8, the holder 16 may include a first side surface 30 located between the upper surface 26 and the lower surface 28, and the first side surface 30 may extend in the X direction from the front end surface 22, toward the rear end 16b, to the rear end surface 24. The first side surface 30 of the holder 16 may be connected to the upper surface 26 and the lower surface 28. In the body portion 16m of the holder 16, the first side surface 30 may be orthogonal to the lower surface 28 and the upper surface 26. Note that FIG. 6 is a front view of the above-described first side surface 30.

The holder 16 may include a second side surface 32 located on a side opposite to the first side surface 30, and the second side surface 32 may extend in the X direction from the front end surface 22, toward the rear end 16b, to the rear end surface 24. The second side surface 32 of the holder 16 may be connected to the upper surface 26 and the lower surface 28. In the body portion 16m of the holder 16, the second side surface 32 may be orthogonal to the lower surface 28 and the upper surface 26. Note that FIG. 2 is a front view of the above-described second side surface 32.

As illustrated in FIGS. 4 to 6 and FIG. 8, the holder 16 may include a pocket 34 for holding the cutting insert 18, on the side of the front end 16a. The pocket 34 of the holder 16 may be open at the front end surface 22, the upper surface 26, and the first side surface 30. The holder 16 may include a screw hole 36 (see FIG. 7) located on the front end 16a side. The screw hole 36 of the holder 16 may be open at the pocket 34 and the lower surface 28.

Examples of the material of the holder 16 include metals such as stainless steel, carbon steel, cast iron, and an aluminum alloy. The length of the holder 16 may be set to be, for example, from 100 mm to 400 mm.

As illustrated in FIGS. 4 to 6 and FIG. 8, the cutting insert 18 may be located at the pocket 34 of the holder 16. The cutting insert 18 may be a replaceable insert called a throw-away insert. The cutting insert 18 may have a quadrangular plate shape, or may have a triangular plate shape or a pentagonal plate shape other than the quadrangular plate shape. The cutting insert 18 may include a first insert surface 38, a second insert surface 40 located on a side opposite to the first insert surface 38, and a plurality of insert side surfaces 42 located between the first insert surface 38 and the second insert surface 40.

The cutting insert 18 may include a cutting edge 44 at an intersection between the first insert surface 38 and the insert side surface 42. The cutting edge 44 may be located at the front end 16a of the holder 16 and on a side of the first side surface 30. The first insert surface 38 may function as a rake face for flushing out chips. A portion, of the first insert surface 38, that functions as the rake face may be substantially parallel to the upper surface 26 of the holder 16. The insert side surface 42 may function as a flank face.

The cutting insert 18 may include a through hole that opens to the first insert surface 38 and the second insert surface 40. The through hole of the cutting insert 18 may be aligned with the screw hole 36 of the holder 16. The cutting insert 18 is attached to the pocket 34 of the holder 16 by screwing and tightening the clamp screw 20 inserted through the through hole of the cutting insert 18, into the screw hole 36 of the holder 16.

Examples of the material of the cutting insert 10 include a cemented carbide alloy and a cermet. The composition of the cemented carbide alloy includes WC—Co, WC—TiC—Co, and WC—TiC—TaC—Co, for example. WC—Co is produced by adding cobalt (Co) powder to tungsten carbide (WC) and sintering this mixture. WC—TiC—Co is formed by adding titanium carbide (TiC) to WC—Co. WC—TiC—TaC—Co is formed by adding tantalum carbide (TaC) to WC—TiC—Co. Cermet is a sintered composite material in which a metal is combined with a ceramic component. Specifically, examples of the cermet include compounds in which a titanium compound such as titanium carbide (TiC) and titanium nitride (TiN) is the primary component.

The surface of the cutting insert 18 may be coated with a coating film using a chemical vapor deposition (CVD) method or a physical vapor deposition (PVD) method. Examples of the material of the coating film include titanium carbide (TiC), titanium nitride (TiN), titanium carbonitride (TiCN), and alumina (Al₂O₃).

Although the above-described cutting tool 12 is constituted by the holder 16 and the cutting insert 18, a solid-type cutting tool constituted by one member may be used.

As in the example illustrated in FIGS. 1 to 3, the cutting tool rest 14 according to the embodiment of the present disclosure may include a holding block 46, a clamp member 48 that fixes the holder 16 to the holding block 46, and a plurality of fixing bolts 50 for attaching the clamp member 48 to the holding block 46. The holding block 46 is mounted on a machining head of a lathe.

The holding block 46 may include a plurality of grooves 52 for holding (accommodating) the body portion 16m of the holder 16, and the plurality of grooves 52 may be arranged at intervals in the Z direction. The groove 52 of the holding block 46 may extend in the X direction. Both ends of the groove 52 of the holding block 46 in the X direction may be open. The number of grooves 52 of the holding block 46 may be one.

As in the example illustrated in FIGS. 1 to 3 and FIG. 9, the groove 52 of the holding block 46 may include a bottom surface 52a and a pair of inner side surfaces 52b and 52c rising from both sides of the bottom surface 52a. One inner side surface (first inner side surface) 52b of the groove 52 of the holding block 46 may include a guide surface 52g. The guide surface 52g of the groove 52 of the holding block 46 may be inclined with respect to the depth direction (a direction parallel to the Y direction) of each of the grooves 52 so as to approach a center line 52s of the groove 52 with increasing proximity to the bottom surface 52s.

The bottom surface 52a of the groove 52 of the holding block 46 may come into contact with the first side surface 30 of the holder 16. The other inner side surface (second inner side surface) 52c of the groove 52 of the holding block 46 may come into contact with the lower surface 28 of the holder 16. In other words, the first side surface 30 of the holder 16 may come into contact with the bottom surface 52a of the groove 52 of the holding block 46. The lower surface 28 of the holder 16 may come into contact with the other inner side surface 52c of the groove 52 of the holding block 46.

As in the example illustrated in FIGS. 1 to 3, the holding block 46 may include, at one edge portion of each of the grooves 52, a plurality of screw holes 54 into which the fixing bolts 50 are screwed. Examples of the material of the holding block 46 include metals such as stainless steel, carbon steel, and cast iron.

As in the example illustrated in FIGS. 1, 2 and 9, the clamp member 48 may be located at the one edge portion of the groove 52 of the holding block 46. The clamp member 48 may be attached to the one edge portion of the groove 52 of the holding block 46 by the plurality of fixing bolts 50. The clamp member 48 may extend in the X direction, and the shape of the clamp member 48 if viewed from the X direction may be an L-shape.

The clamp member 48 may include an attachment piece 56 as an attachment portion attachable to the one edge portion of the groove 52 of the holding block 46, and the attachment piece 56 may extend in the X direction. The attachment piece 56 may include a plurality of through holes 58 (see FIG. 14) through which the fixing bolts 50 are inserted, and the plurality of through holes 58 may be arranged at intervals in the X direction. Each of the through holes 58 of the attachment piece 56 may be aligned with each of the screw holes 54 of the holding block 46.

As in the example illustrated in FIGS. 2 and 9, the clamp member 48 may include a pressing piece 60 as a pressing portion that presses the holder 16 toward a side of the other inner side surface (second inner side surface) 52c of the groove 52 of the holding block 46. The pressing piece 60 may press the holder 16 toward the other inner side surface 52b of the groove 52 of the holding block 46 in a state of being interposed between the one inner side surface (first inner side surface) 52c of the groove 52 of the holding block 46 and the upper surface 26 of the holder 16. The pressing piece 60 may extend in the X direction and may protrude from an edge portion of the attachment piece 56. The protruding direction of the attachment piece 56 may be the Y direction.

As in the example illustrated in FIG. 9, the pressing piece 60 may include a sliding surface 60f that slides on the guide surface 52g of the groove 52 of the holding block 46. The sliding surface 60f of the pressing piece 60 may be inclined with respect to the protruding direction of the pressing piece 60 so as to approach the center line 52s of the groove 52 of the holding block 46 toward the protruding direction of the pressing piece 60. Examples of the material of the clamp member 48 include metals such as stainless steel, carbon steel, and cast iron.

Each of the fixing bolts 50 inserted into each of the through holes 58 of the attachment piece 56 is screwed and tightened into the screw hole 54 of the holding block 46, thereby realizing a wedge effect by the sliding surface 60f of the pressing piece 60 of the clamp member 48, and the guide surface 52g of the groove 52 of the holding block 46. Accordingly, the pressing piece 60 of the clamp member 48 presses the holder 16 toward the other inner side surface 52c of the groove 52 of the holding block 46, so that the holder 16 can be fixed to the holding block 46.

As in the example illustrated in FIGS. 2, 6, and 7, the lower surface 28 of the holder 16 may include a stepped portion 62 having a protrusively curved shape that is protrusively toward the rear end 16b. The stepped portion 62 of the holder 16 may be in contact with an end surface 48e of the holding block 46. The holder 16 can be positioned with respect to the groove 52 of the holding block 46 by bringing the stepped portion 62 of the holder 16 into contact with the end surface 48e of the holding block 46 in a state in which the body portion 16m of the holder 16 is held in the groove 52 of the holding block 46.

As in the example illustrated in FIGS. 4 to 6, the upper surface 26 of the holder 16 may include a first cutout 64 located on a side of one end of the body portion 16m. The first cutout 64 of the holder 16 may include a first inclined surface 64f that is inclined with respect to a virtual surface VF parallel to the lower surface 28, so as to be separate from the lower surface 28 with increasing proximity to a side of the rear end 16b. The first cutout 64 of the holder 16 may be open at the first side surface 30 and the second side surface 32.

As in the example illustrated in FIGS. 4 to 6, the upper surface 26 of the holder 16 may include a second cutout 66 located closer to the rear end 16b than the first cutout 64. The second cutout 66 of the holder 16 may include a second inclined surface 66f that is inclined with respect to the virtual plane VF parallel to the lower surface 28, so as to be separate from the lower surface 28 with increasing proximity to the side of the rear end 16b. The second cutout 66 of the holder 16 may be open at the first side surface 30 and the second side surface 32.

As in the example illustrated in FIG. 5, a width B1 of the first cutout 64 of the holder 16 in the X direction, which is the longitudinal direction of the holder 16, may be larger on a side of the second side surface 32 than on the side of the first side surface 30. A width B2 of the second cutout 66 of the holder 16 in the X direction may be larger on the side of the second side surface 32 than on side of the first side surface 30.

As in the example illustrated in FIGS. 10 and 11, a depth D1 of the first cutout 64 of the holder 16 may be deeper on the side of the second side surface 32 than on the side of the first side surface 30. A depth D2 of the second cutout 66 of the holder 16 may be deeper on the side of the second side surface 32 side than on the side of the first side surface 30. In a cross section orthogonal to the longitudinal direction of the holder 16, an inclination angle θ1 of the first inclined surface 64f of the first cutout 64 with respect to the virtual plane VF parallel to the lower surface 28 may be larger than an inclination angle θ2 of the second inclined surface 66f of the second cutout 66 with respect to the virtual plane VF parallel to the lower surface 28. A maximum value of the depth D1 of the first cutout 64 of the holder 16 may be larger than a maximum value of the depth D2 of the second cutout 66.

As in the example illustrated in FIGS. 12 to 14, the pressing piece 60 may include a first protrusion 68 that comes into contact with the first inclined surface 64f of the first cutout 64 of the holder 16, and the first protrusion 68 may protrude in a direction orthogonal to the longitudinal direction of the clamp member 48. The first protrusion 68 of the pressing piece 60 may be located on a side of one end 48a of the clamp member 48. The first protrusion 68 of the pressing piece 60 may include a first contact surface 68f that comes into contact with the first inclined surface 64f of the first cutout 64 of the holder 16.

As in the example illustrated in FIG. 14, in a cross section along the longitudinal direction of the clamp member 48, the width B1 of the first cutouts 64 of the holder 16 may be larger than a width T1 of the first protrusion 68 of the pressing piece 60. The first inclined surface 64f of the first cutout 64 of the holder 16 may be a flat surface, and the first contact surface 68f of the first protrusion 68 of the pressing piece 60 may be a protrusively curved surface. Alternatively, the first inclined surface 64f of the first cutout 64 of the holder 16 may be a protrusively curved surface, and the first contact surface 68f of the first protrusion 68 of the pressing piece 60 may be a flat surface.

The pressing piece 60 may include a second protrusion 70 that comes into contact with the second inclined surface 66f of the second cutout 66 of the holder 16, and the second protrusion 70 may protrude in the direction orthogonal to the longitudinal direction of the clamp member 48. The second protrusion 70 of the pressing piece 60 may be separated from the first protrusion 68 toward a side of another end 48b of the clamp member 48. The second protrusion 70 of the pressing piece 60 may include a second contact surface 70f that comes into contact with the second inclined surface 66f of the second cutout 66 of the holder 16.

As in the example illustrated in FIG. 14, in the cross section along the longitudinal direction of the clamp member 48, the width B2 of the second cutout 66 of the holder 16 may be larger than a width T2 of the second protrusion 77 of the pressing piece 60. The second inclined surface 66f of the second cutout 66 of the holder 16 may be a flat surface, and the second contact surface 70f of the second protrusion 70 of the pressing piece 60 may be a protrusively curved surface. Alternatively, the second inclined surface 66f of the second cutout 66 of the holder 16 may be a protrusively curved surface, and the second contact surface 70f of the second protrusion 70 of the pressing piece 60 may be a flat surface.

According to an example of the embodiment of the present disclosure, the pressing piece 60 includes the first protrusion 68 that comes into contact with the first inclined surface 64f of the first cutout 64 of the holder 16, and the second protrusion 70 that comes into contact with the second inclined surface 66f of the second cutout 66 of the holder 16. Therefore, the pressing force of the first protrusion 68 of the pressing piece 60 with respect to the first cutout 64 of the holder 16 and the pressing force of the second protrusion 70 of the pressing piece 60 with respect to the second cutout 66 of the holder 16 can be adjusted at the same time without individually adjusting the pressing forces. As a result, the holder 16 can be easily attached to the holding block 46 while reducing a difference between the pressing force of the first protrusion 68 of the pressing piece 60 and the pressing force of the second protrusion 70 of the pressing piece 60. Accordingly, according to the example of the embodiment of the present disclosure, the holder 16 can be stably held by the holding block 46 while improving the workability of an operation of attaching the holder 16 to the holding block 46. In other words, the cutting tool 12 can be stably held by the cutting tool rest 14 while improving the workability of the operation of attaching the cutting tool 12 to the cutting tool rest 14.

If the first cutout 64 and the second cutout 66 of the holder 16 are open at the first side surface 30 and the second side surface 32, respectively, the first protrusion 68 and the second protrusion 70 of the pressing piece 60 can be easily brought into contact with the first inclined surface 64f of the first cutout 64 and the second inclined surface 66f of the second cutout 66 of the holder 16, respectively. Accordingly, the workability of the operation of attaching the holder 16 to the holding block 46 can be further improved.

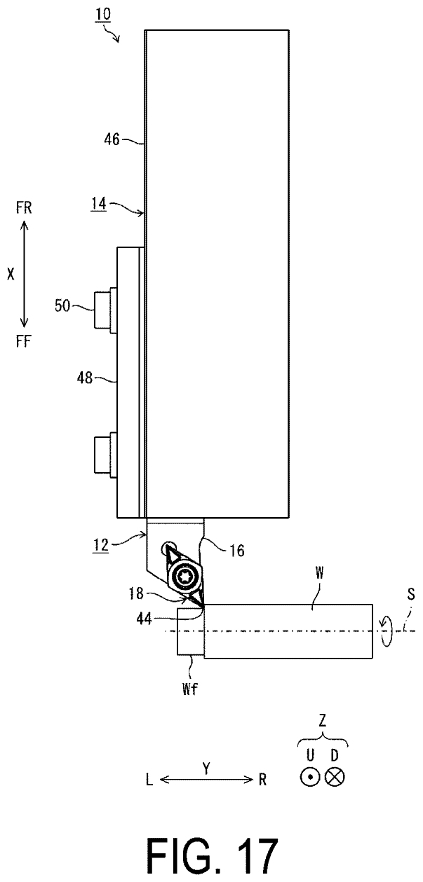

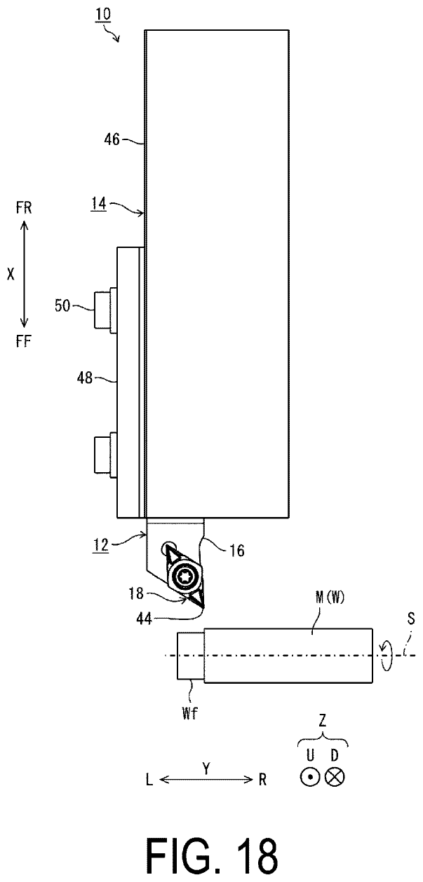

If the first side surface 30 of the holder 16, which is close to the cutting edge 44, is in contact with the bottom surface 52a of the groove 52 of the holding block 46, the holding block 46 is more likely to absorb chatter vibration during cutting. Accordingly, the chatter vibration can be reduced, and the surface roughness of a machined surface Wf (see FIGS. 17 and 18) of the workpiece W can be improved.

If the width B1 of the first cutout 64 of the holder 16 in the X direction is larger on the side of the second side surface 32 than on the side of the first side surface 30, the first protrusion 68 of the pressing piece 60 can be easily brought into contact with the first inclined surface 64f of the first cutout 64 of the holder 16. Accordingly, the workability of the operation of attaching the holder 16 to the holding block 46 can be further improved.

If the width B2 of the second cutout 66 of the holder 16 in the X direction is larger on the side of second side surface 32 than on the side of the first side surface 30, the second protrusion 70 of the pressing piece 60 can be easily brought into contact with the second inclined surface 66f of the second cutout 66 of the holder 16. Accordingly, the workability of the operation of attaching the holder 16 to the holding block 46 can be further improved.

If the depth D1 of the first cutout 64 of the holder 16 is deeper on the side of the second side surface 32 side than on the side of the first side surface 30 side, the first protrusion 68 of the pressing piece 60 can be easily brought into contact with the first inclined surface 64f of the first cutout 64 of the holder 16. Accordingly, the workability of the operation of attaching the holder 16 to the holding block 46 can be further improved.

If the depth D2 of the second cutout 66 of the holder 16 is deeper on the side of the second side surface 32 than on the side of the first side surface 30, the second protrusion 70 of the pressing piece 60 can be easily brought into contact with the second inclined surface 66f of the second cutout 66 of the holder 16. Accordingly, the workability of the operation of attaching the holder 16 to the holding block 46 can be further improved.

In particular, if the inclination angle θ1 of the first inclined surface 64f of the first cutout 64 is larger than the inclination angle θ2 of the second inclined surface 66f of the second cutout 66 in the cross section orthogonal to the longitudinal direction of the holder 16, the holder 16 can be firmly fixed to the holding block 46 at the first cutout 64 close to the cutting edge 44. Accordingly, the machining accuracy of cutting the workpiece W can be improved.

If the maximum value of the depth D1 of the first cutout 64 of the holder 16 is larger than the maximum value of the depth D2 of the second cutout 66, the holder 16 can be firmly fixed to the holding block 46 at the first cutout 64 close to the cutting edge 44. Accordingly, the machining accuracy of cutting the workpiece W can be improved.

If the width B1 of the first cutout 64 of the holder 16 is larger than the width T1 of the first protrusion 68 of the pressing piece 60 in the cross section along the longitudinal direction of the clamp member 48, the first protrusion 68 of the pressing piece 60 can be easily brought into contact with the first inclined surface 64f of the first cutout 64 of the holder 16. Accordingly, the workability of the operation of attaching the holder 16 to the holding block 46 can be further improved.

If the width B2 of the second cutout 66 of the holder 16 is larger than the width T2 of the second protrusion 77 of the pressing piece 60 in the cross section along the longitudinal direction of the clamp member 48, the second protrusion 70 of the pressing piece 60 can be easily brought into contact with the second inclined surface 66f of the second cutout 66 of the holder 16. Accordingly, the workability of the operation of attaching the holder 16 to the holding block 46 can be further improved.

If the first inclined surface 64f of the first cutout 64 of the holder 16 is a flat surface and the first contact surface 68f of the first protrusion 68 of the pressing piece 60 is a protrusively curved surface, the first contact surface 68f of the first protrusion 68 can be stably brought into surface contact with the first inclined surface 64f of the first cutout 64 without machining the first cutout 64 and the first protrusion 68 under strict manufacturing conditions. Accordingly, the manufacturing cost of the cutting unit 10 can be reduced.

If the first inclined surface 64f of the first cutout 64 of the holder 16 is a protrusively curved surface and the first contact surface 68f of the first protrusion 68 of the pressing piece 60 is a flat surface, the first contact surface 68f of the first protrusion 68 can be stably brought into surface contact with the first inclined surface 64f of the first cutout 64 without machining the first cutout 64 and the first protrusion 68 under strict manufacturing conditions. Accordingly, the manufacturing cost of the cutting unit 10 can be reduced.

If the first inclined surface 64f of the first cutout 64 of the holder 16 and the first contact surface 68f of the first protrusion 68 of the pressing piece 60 are flat surfaces, it is necessary to ensure parallelism between the first contact surface 68f of the first cutout 64 and the first inclined surface 64f of the first protrusion 68, in order to bring the first contact surface 68f and the first inclined surface 64f into surface contact with each other. Therefore, in the above-described case, it is necessary to machine the first cutout 64 and the first protrusion 68 under strict manufacturing conditions.

If the second inclined surface 66f of the second cutout 66 of the holder 16 is a flat surface and the second contact surface 70f of the second protrusion 70 of the pressing piece 60 is a protrusively curved surface, the second contact surface 70f of the second protrusion 70 can be stably brought into surface contact with the second inclined surface 66f of the second cutout 66 without machining the second cutout 66 and the second protrusion 70 under strict manufacturing conditions. Accordingly, the manufacturing cost of the cutting unit 10 can be reduced.

If the second inclined surface 66f of the second cutout 66 of the holder 16 is a protrusively curved surface and the second contact surface 70f of the second protrusion 70 of the pressing piece 60 is a flat surface, the second contact surface 70f of the second protrusion 70 can be stably brought into surface contact with the second inclined surface 66f of the second cutout 66 without machining the second cutout 66 and the second protrusion 70 under strict manufacturing conditions. Accordingly, the manufacturing cost of the cutting unit 10 can be reduced.

If the second inclined surface 66f of the second cutout 66 of the holder 16 and the second contact surface 70f of the second protrusion 70 of the pressing piece 60 are flat surfaces, it is necessary to ensure parallelism between the second inclined surface 66f of the second cutout 66 and the second contact surface 70f of the second protrusion 70, in order to bring the second inclined surface 66f and the second contact surface 70f into surface contact with each other. Therefore, in the above-described case, it is necessary to machine the second cutout 66 and the second protrusion 70 under strict manufacturing conditions.

### Method for Manufacturing Cut Article

A description will be given of a method for manufacturing a cut article according to the embodiment of the present disclosure with reference to FIGS. 16 to 18. FIGS. 16 to 18 are schematic views illustrating the method for manufacturing the cut article according to the embodiment of the present disclosure.

As in the example illustrated in FIGS. 16 to 18, the method for manufacturing the cut article according to the embodiment of the present disclosure is a method for manufacturing a cut article M, which is the machined workpiece W, and includes a first step, a second step, and a third step. The first step is a step of rotating the workpiece W about an axial center S thereof. The second step is a step of bringing the cutting edge 44 of the cutting insert 18 of the cutting unit 10 into contact with the rotating workpiece W, and cutting the workpiece W. The third step is a step of separating the cutting edge 44 of the cutting insert 18 from the cut workpiece W. Examples of the material of the workpiece W include stainless steel, carbon steel, alloy steel, cast iron, and a non-ferrous metal. The specific content of the method for manufacturing the cut article according to the embodiment is as follows.

First, the cutting unit 10 is attached to a machining head of a lathe, and the workpiece W is attached to a chuck of the lathe. Subsequently, as in the example illustrated in FIG. 16, the chuck is rotated to rotate the workpiece W about the axial center S thereof (first step). Then, as in the example illustrated in FIG. 17, the cutting unit 10 is brought close to an end surface of the workpiece W and moved along the axial center S of the workpiece W. By bringing the cutting edge 44 of the cutting insert 18 close to the workpiece W, bringing the cutting insert 18 into contact with the rotating workpiece W, and cutting the workpiece W (second step). the machined surface Wf can be formed at the workpiece W.

After that, as in the example illustrated in FIG. 16, by moving the cutting unit 10 in a direction away from the axial center S of the workpiece W, the cutting edge 44 of the cutting insert 18 is separated from the workpiece W (third step). This completes the cutting of the workpiece W and enables the cut article M, which is the cut workpiece W, to be manufactured. Since the cutting unit 10 has excellent cutting capabilities because of the above-described reasons, the cut article M having an excellent machining accuracy can be manufactured.

If the cutting is continued, the cutting edge 44 of the cutting insert 18 may be repeatedly brought into contact with a different portion of the workpiece W while the workpiece W is being rotated. Although the cutting edge 44 of the cutting insert 18 is brought close to the workpiece W in the embodiment of the present disclosure, the cutting edge 44 of the cutting insert 18 only needs to be brought relatively close to the workpiece W. Thus, the workpiece W may be brought close to the cutting edge 44 of the cutting insert 18. In this respect, the same procedure is performed if separating the cutting edge 44 of the cutting insert 18 from the workpiece W.

According to an embodiment, (1) a cutting unit has a quadrangular prism shape extending from a front end toward a rear end, and includes a holder including a front end surface located on a side of the front end, an upper surface extending from the front end surface toward the rear end, a lower surface located on a side opposite to the upper surface, a first side surface located between the upper surface and the lower surface and extending from the front end surface toward the rear end, and a second side surface located on a side opposite to the first side surface, a cutting edge located at the front end and on a side of the first side surface, a holding block including a groove configured to hold the holder, and a clamp member located at the holding block, the clamp member comprising a pressing portion and being configured to fix the holder to the holding block, and the pressing portion being configured to, in a state of being interposed between one inner side surface of the groove and the upper surface, press the holder toward a side of another inner side surface of the groove. The upper surface includes a first cutout including a first inclined surface that becomes increasingly separated from the lower surface with increasing proximity to a side of the rear end, and a second cutout located closer to the rear end than the first cutout, and including a second inclined surface that becomes increasingly separated from the lower surface with increasing proximity to the side of the rear end. The pressing portion includes a first protrusion configured to be in contact with the first inclined surface, and a second protrusion separated from the first protrusion and configured to be in contact with the second inclined surface.

(2) In the cutting unit according to (1) described above, the first cutout and the second cutout may be open at the first side surface and the second side surface, respectively.

(3) In the cutting unit according to (1) or (2) described above, the first side surface may be in contact with a bottom surface of the groove.

(4) In the cutting unit according to any one of (1) to (3) described above, a width, in a longitudinal direction, of the holder at the first cutout may be larger on a side of the second side surface than on the side of the first side surface.

(5) In the cutting unit according to any one of (1) to (4) described above, a depth of the first cutout may be deeper on a side of the second side surface than on the side of the first side surface.

(6) In the cutting unit according to any one of (1) to (5) described above, a depth of the second cutout may be deeper on a side of the second side surface than on the side of the first side surface, and in a cross section orthogonal to the longitudinal direction of the holder, an inclination angle of the first inclined surface with respect to a virtual line parallel to the lower surface may be larger than an inclination angle of the second inclined surface with respect to the virtual line parallel to the lower surface.

(7) In the cutting unit according to any one of (1) to (6) described above, a maximum value of a depth of the first cutout may be larger than a maximum value of a depth of the second cutout.

(8) In the cutting unit according to any one of (1) to (7) described above, the first protrusion may include a first contact surface configured to be in contact with the first inclined surface, and the first inclined surface may be a flat surface and the first contact surface may be a protrusively curved surface.

(9) In the cutting unit according to any one of (1) to (7) described above, the first protrusion may include a first contact surface configured to be in contact with the first inclined surface, and the first inclined surface may be a protrusively curved surface and the first contact surface may be a flat surface.

(10) In the cutting unit according to any one of (1) to (9) described above, in a cross section along a longitudinal direction of the clamp member, a width of the first cutout may be larger than a width of the first protrusion.

(11) A cutting tool has a quadrangular prism shape extending from a front end toward a rear end, and includes a holder including a front end surface located on a side of the first end, an upper surface extending from the front end surface toward the rear end, a lower surface located on a side opposite to the upper surface, a first side surface located between the upper surface and the lower surface and extending from the front end surface toward the rear end, and a second side surface located on a side opposite to the first side surface, and a cutting edge located at the front end and on a side of the first side surface. The upper surface includes a first cutout including a first inclined surface that becomes increasingly separated from the lower surface with increasing proximity to a side of the rear end, the first cutout being open at the first side surface and the second side surface, and a second cutout located closer to the rear end than the first cutout, and including a second inclined surface that becomes increasingly separated from the lower surface with increasing proximity to the side of the rear end, the second cutout being open at the first side surface and the second side surface.

(12) A cutting tool rest, to which the cutting tool according to (11) described above is attachable, includes a holding block including a groove configured to hold a holder of the cutting tool, and a clamp member located at the holding block, the clamp member including a pressing portion and being configured to fix the holder to the holding block, and the pressing portion being configured to, in a state of being interposed between one inner side surface of the groove and the upper surface, press the holder toward a side of another inner side surface of the groove. The pressing portion includes a first protrusion configured to be in contact with the first inclined surface, and a second protrusion separated from the first protrusion and configured to be in contact with the second inclined surface.

(13) A method for manufacturing a cut article includes rotating a workpiece, bringing the cutting edge of the cutting unit according to any one of claims 1 to 10 into contact with the workpiece that is rotating; and separating the cutting edge of the cutting unit from the workpiece.

In the present disclosure, the invention has been described above based on the drawings and embodiment. However, the invention according to the present disclosure is not limited to the above-described embodiment. In other words, the invention according to the present disclosure can be modified in various ways within the scope illustrated in the present disclosure, and embodiments obtained by appropriately combining the technical means disclosed in different embodiments are also included in the technical scope of the invention according to the present disclosure. In other words, note that those skilled in the art can easily make various variations or modifications based on the present disclosure. Note that such variations or modifications are included within the scope of the present disclosure.

### REFERENCE SIGNS

10 Cutting unit
12 Cutting tool
14 Cutting tool rest
16 Holder
16a Front end
16b Rear end
16m Body portion
18 Cutting insert
20 Clamp screw
22 Front end surface
24 Rear end surface
26 Upper surface
28 Lower surface
30 First side surface
32 Second side surface
34 Pocket
36 Screw hole
38 First insert surface
40 Second insert surface
42 Insert side surface
44 Cutting edge
46 Holding block
48 Clamp member
50 Fixing bolt
52 Groove
52a Bottom surface
52b One inner side surface (first inner side surface)
52c Other inner side surface (second inner side surface)
52g Guide surface
52s Center line
54 Screw hole
56 Attachment piece (attachment portion)
58 Through hole
60 Pressing piece (pressing portion)
60f Sliding surface
62 Stepped portion
64 First cutout
64f First inclined surface
66 Second cutout
66f Second inclined surface
68 First protrusion
68f First contact surface
70 Second protrusion
70f Second contact surface

1. A cutting unit comprising:
a holder having a quadrangular prism shape extending from a front end toward a rear end, and comprising
a front end surface located on a side of the front end,
an upper surface extending from the front end surface toward the rear end,
a lower surface located on a side opposite to the upper surface,
a first side surface located between the upper surface and the lower surface and extending from the front end surface toward the rear end, and
a second side surface located on a side opposite to the first side surface;
a cutting edge located on a side of the front end and the first side surface;
a holding block comprising a groove which is configured to hold the holder and comprises a first and second inner surface; and
a clamp member
located at the holding block,
comprising a pressing portion configured to press the holder toward a side of another inner side surface of the groove in a state of being interposed between the second inner side surface of the groove and the upper surface, and
configured to fix the holder to the holding block,
wherein
the upper surface comprises
a first cutout comprising a first inclined surface being separated from the lower surface as closer to the rear end, and
a second cutout located closer to the rear end than the first cutout, and comprising a second inclined surface being separated from the lower surface as closer to the rear end, and
the pressing portion comprises
a first protrusion configured to be in contact with the first inclined surface, and
a second protrusion separated from the first protrusion and configured to be in contact with the second inclined surface.

2. The cutting unit according to claim 1, wherein
the first cutout is open at the first side surface, and
the second cutout is open the second side surface.

3. The cutting unit according to claim 1, wherein
the first side surface is in contact with a bottom surface of the groove.

4. The cutting unit according to claim 1, wherein
a width, in a longitudinal direction, of the holder at the first cutout is larger on a side of the second side surface than on
the side of the first side surface.

5. The cutting unit according to claim 1, wherein
a depth of the first cutout is deeper on a side of the second side surface than on the side of the first side surface.

6. The cutting unit according to claim 1, wherein
a depth of the second cutout is deeper on a side of the second side surface than on the side of the first side surface, and
in a cross section orthogonal to the longitudinal direction of the holder, an inclination angle of the first inclined surface with respect to a virtual line parallel to the lower surface is larger than an inclination angle of the second inclined surface with respect to the virtual line parallel to the lower surface.

7. The cutting unit according to claim 1, wherein
a maximum value of a depth of the first cutout is larger than a maximum value of a depth of the second cutout.

8. The cutting unit according to claim 1, wherein
the first protrusion comprises a first contact surface configured to come into contact with the first inclined surface, and
the first inclined surface is a flat surface and the first contact surface is a protrusively curved surface.

9. The cutting unit according to claim 1, wherein
the first protrusion comprises a first contact surface configured to come into contact with the first inclined surface, and
the first inclined surface is a protrusively curved surface and the first contact surface is a flat surface.

10. The cutting unit according to claim 1, wherein
in a cross section along a longitudinal direction of the clamp member, a width of the first cutout is larger than a width of the first protrusion.

11. A cutting tool comprising:
a holder having a quadrangular prism shape extending from a front end toward a rear end, the cutting tool and comprising
a front end surface located on a side of the first end,
an upper surface extending from the front end surface toward the rear end,
a lower surface located on a side opposite to the upper surface,
a first side surface located between the upper surface and the lower surface and extending from the front end surface toward the rear end, and
a second side surface located on a side opposite to the first side surface; and
a cutting edge located at the front end and on a side of the first side surface, wherein the upper surface comprises
a first cutout comprising a first inclined surface being separated from the lower surface as closer to the rear end, the first cutout being open at the first side surface and the second side surface, and
a second cutout located closer to the rear end than the first cutout, and comprising a second inclined surface being separated from the lower surface as closer to the rear end, the second cutout being open at the first side surface and the second side surface.

12. A cutting tool rest to which the cutting tool according to claim 11 is attachable, the cutting tool rest comprising:
a holding block comprising a groove configured to hold a holder of the cutting tool; and
a clamp member
located at the holding block,
comprising a pressing portion configured to press the holder toward a side of another inner side surface of the groove in a state of being interposed between the second inner side surface of the groove and the upper surface, and
configured to fix the holder to the holding block,
wherein
the pressing portion comprises
a first protrusion configured to be in contact with the first inclined surface, and
a second protrusion separated from the first protrusion and configured to be in contact with the second inclined surface.

13. A method for manufacturing a machined product, the method comprising:
rotating a workpiece;
bringing the cutting edge of the cutting unit according to claim 1 into contact with the workpiece that is rotating; and
separating the cutting edge of the cutting unit from the workpiece.
